(19) United States
(12) Patent Application Publication
(10) Pub. No.: US 2007/0147484 A1
(43) Pub. Date: Jun. 28, 2007

(54) Apparatus and method for signal matching in a communication system

(75) Inventor: Jun-Sung Lee, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS., LTD., Suwon-si (KR)

(21) Appl. No.: 11/645,959

(22) Filed: Dec. 27, 2006

(30) Foreign Application Priority Data
Dec. 27, 2005 (KR) 2005/130837

(51) Int. Cl. H04B 1/00; H04K 1/10

(52) U.S. Cl. 375/149; 375/260

(57) ABSTRACT

A signal matching apparatus and method in a communication system are provided. For signal matching, a transmitter generates a synchronization code for synchronization acquisition, includes the synchronization code on a center frequency subcarrier of a transmission signal, and sends the transmission signal to a receiver. The receiver detects the synchronization code from the center frequency subcarrier of the received signal and performs signal matching to the transmitter using the synchronization code.

### PRIORITY

This application claims priority under 35 U.S.C. § 119(a) to a Korean Patent Application filed in the Korean Intellectual Property Office on Dec. 27, 2005 and assigned Ser. No. 2005-130837, the disclosure of which is incorporated herein by reference.

### BACKGROUND OF THE INVENTION

1. Field of the Invention

The present invention generally relates to a communication system, and in particular, to an apparatus and method for matching transmission and reception signals between communication devices.

2. Description of the Related Art

Today, communication technology is evolving to enable high-speed transmission of a variety of information at any place around the globe, overcoming the limitations of terminal mobility and transmission rate that legacy communication systems faced. Communication systems are developed with the aim to additionally provide multimedia service of high-speed data, video, and the like including Internet service, beyond simple voice service.

These communication systems operate in a duplexing scheme. Frequency Division Duplexing (FDD) and Time Division Duplexing (TDD) are the two most prevalent duplexing schemes. FDD uses two distinct radio channels for signal transmission and reception, and TDD distinguishes signal transmission and reception by time division.

In view of the nature of FDD, i.e. the use of different frequencies for signal transmission and reception, a transmitter (e.g. Base Station (BS)) and a receiver (e.g. Mobile Station (MS)) each should be provided with a Transmit (Tx) antenna and a Receive (Rx) antenna.

Compared to FDD, since TDD makes a distinction of transmission and reception in time, a single antenna suffices for signal transmission and reception in each of the transmitter and the receiver. That is, due to the use of the same frequency for transmission and reception, a Tx time period and an Rx time period are preset and signal transmission and reception are carried out during the Tx time period and the Rx time period, respectively. Despite increased scheduling complexity in signal transmission and reception, TDD is the more efficient scheme in terms of frequency use efficiency and thus resource use efficiency.

A TDD communication system, particularly a TDD communication system adopting a device such as a repeater for signal transmission and reception will be described below. The repeater serves to eliminate a propagation shadowing area inherent to network implementation and to expand service coverage. Typically, the repeater is installed between the BS and the MS, for relaying communications between them by amplifying received signals. Depending on the type of connectivity to the BS, repeaters are categorized into an optical repeater and a Radio Frequency (RF) repeater. The optical repeater is connected to the BS by an optical link and the RF repeater is connected to the BS in an RFmanner.

Repeaters for signal transmission and reception in the TDD communication system will be described below.

FIG. 1 illustrates the structure of an RF repeater in a typical broadband wireless communication system.

Referring to FIG. 1, the broadband wireless communication system includes a BS 100, an RF repeater 150, and an MS 190. The RF repeater 150 has a first filter 151, a second filter 159, a first switch 153, a second switch 157, a first AMPlifier (AMP) 155, a second AMP 161, and a level detector 163. The RF repeater 150 further includes an antenna for signal transmission and reception.

For relaying from the BS 100 to the MS 190, the first filter 151 filters a signal received from the BS 100 and the first switch 153 switches the filtered signal to the first AMP 155. The first AMP 155 amplifies the received signal to a predetermined power level and the second switch 157 switches the amplified signal to the second filter 159. The second filter 159 sends the received signal to the MS 190 through the antenna.

For relaying from the MS 190 to the BS 100, the second filter 159 filters a signal received from the MS 190. The second switch 157 switches the filtered signal to the second AMP 161. The second AMP 161 amplifies the received signal to a predetermined power level. The first switch 153 switches the amplified signal to the first filter 151. The first filter 151 sends the received signal to the BS 100 through the antenna.

The level detector 163 converts a variation caused by signal oscillation in the filtered signal received from the first filter 151 to a voltage value. The excess of the voltage value over a predetermined threshold, i.e. the difference between the voltage value and the threshold is attenuated through the first and second filters 151 and 153.

When the MS 190 communicates with the BS 100, the communication is conducted directly, or via the RF repeater 150 if the direct communication is impossible as in a shadowing area or due to a weak signal.

FIG. 2 illustrates the structure of an optical repeater in the typical broadband wireless communication system.

Referring to FIG. 2, the broadband wireless communication system is comprised of a BS 200, an optical repeater 250, and an MS 290.

The BS 200 includes a Modulator-Demodulator (MODEM) 201, a coupler 203, a delay 205, a multiplier 207, an AMP 209, and a donor 211. The optical repeater 250 includes an Opto-Electric (O/E) converter 251, a delay 253, a multiplier 255, and an AMP 257.

The MODEM 201 is responsible for modulation and demodulation of Tx and Rx signals. It modulates a signal generated in the BS 200. The coupler 203 functions to divide a Tx signal into a plurality of signals or combine a plurality of signals to one signal. The coupler 203 distributes the modulated signal to the delay 205 and the donor 211. The delay 205 delays the received signal for a predetermined time. The multiplier 207 provides the delayed signal to the AMP 209. The AMP 209 amplifies the received signal and sends the amplified signal through an antenna.

The donor 211 has an Electro-Optical (E/O) converter 213 and an O/E converter (not shown). The donor 211 converts the electric signal received from the coupler 203 to an optical signal and sends the optical signal to the optical repeater 250. The BS 200 is connected to the repeater 250 by an optical link.

In the optical repeater 250, the O/E converter 251 converts the optical signal received via the optical link to an electrical signal. The delay 253 delays the signal received from the O/E converter 251 for a predetermined time and the multiplier 255 provides the delayed signal to the AMP 257. The AMP 257 amplifies the received signal and sends the amplified signal through an antenna.

The MS 290 may communicate with the BS 200 directly, or via the optical repeater 250 if the direct communication is impossible as in a shadowing area or due to a weak signal.

The repeaters and the communication system using the RF repeater or the optical repeater have been described above with reference to FIGS. 1 and 2. Both the RF repeater and the optical repeater measure the level of a signal received from the BS and recovers TDD Tx-Rx switching timing information. However, the repeaters may suffer performance degradation due to a delay spread longer than the length of a Cyclic Prefix (CP) depending on the distance to the BS. The use of a device such as the repeaters having the constraint of distance leads to a signal mismatch between the transmitter and the receiver, i.e. to a time difference between signal transmission and signal reception. As a consequence, accurate signal detection is not possible. That is, without accurate signal matching between transmission and reception, signals cannot be accurately detected in the communication system. The mismatched signals act as interference. What is worse, total system throughput is decreased.

Accordingly, there is a need for an improved signal matching apparatus and method in a communication system.

### SUMMARY OF THE INVENTION

An aspect of the present invention is to address at least the problems and/or disadvantages and to provide at least the advantages described below. Accordingly, an aspect of the present invention is to provide a signal transmitting and receiving apparatus and method for signal matching between communication devices in a communication system.

Another aspect of the present invention is to provide a signal transmitting and receiving apparatus and method for signal matching between communication devices through accurate signal detection in a communication system.

A further aspect of the present invention is to provide a signal transmitting and receiving apparatus and method for signal matching between communication devices through time synchronization in a communication system.

In accordance with an aspect of the present invention, there is provided a signal matching method in a communication system, in which a synchronization code is generated for synchronization acquisition and included on a center frequency subcarrier of a transmission signal, and the transmission signal is sent to a receiver, for signal matching.

In accordance with another aspect of exemplary embodiments of the present invention, there is provided a signal matching method in a communication system, in which a signal including a synchronization code for synchronization acquisition is received, the synchronization code is detected from a center frequency subcarrier of the received signal, and signal matching is performed by a transmitter which sends the synchronization code, using the synchronization code.

In accordance with a further aspect of the present invention, there is provided a signal matching method in a communication system, in which transmission signals to be sent through a wired link and a wireless link are measured, reception signals received through the wired link and the wireless link are measured, the transmission signals are sent through the wired link and the wireless link by compensating for the difference between transmission timings of the transmission signals so that the transmission timings are synchronized with each other, and the reception signals are received through the wired link and the wireless link by compensating for the difference between reception timings of the received signals so that the reception timings are synchronized with each other.

In accordance with still another aspect of the present invention, there is provided a signal matching apparatus in a communication system, in which a transmitter generates a synchronization code for synchronization acquisition, includes the synchronization code on a center frequency subcarrier of a transmission signal, and sends the transmission signal to a receiver, for signal matching.

In accordance with still another aspect of the present invention, there is provided a signal matching apparatus in a communication system, in which a receiver receives a signal including a synchronization code for synchronization acquisition, detects the synchronization code from a center frequency subcarrier of the received signal, and performs signal matching with a transmitter which sends the synchronization code using the synchronization code.

In accordance with still another aspect of the present invention, there is provided a signal matching apparatus in a communication system, in which a signal measuring portion measures transmission signals to be sent through a wired link and a wireless link and measures reception signals received through the wired link and the wireless link, a signal compensator compensates for the difference between transmission timings of the transmission signals so that the transmission timings are synchronized with each other and compensates for the difference between reception timings of the received signals so that the reception timings are synchronized with each other, and a controller receives transmission signal measurements and reception signal measurements from the signal measuring portion and controls the signal compensator to compensate for the difference between the transmission timings of the transmission signals and to compensate for the difference between the reception timings using the transmission signal measurements and the reception signal measurements.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 illustrates the structure of an RF repeater in a typical broadband wireless communication system;

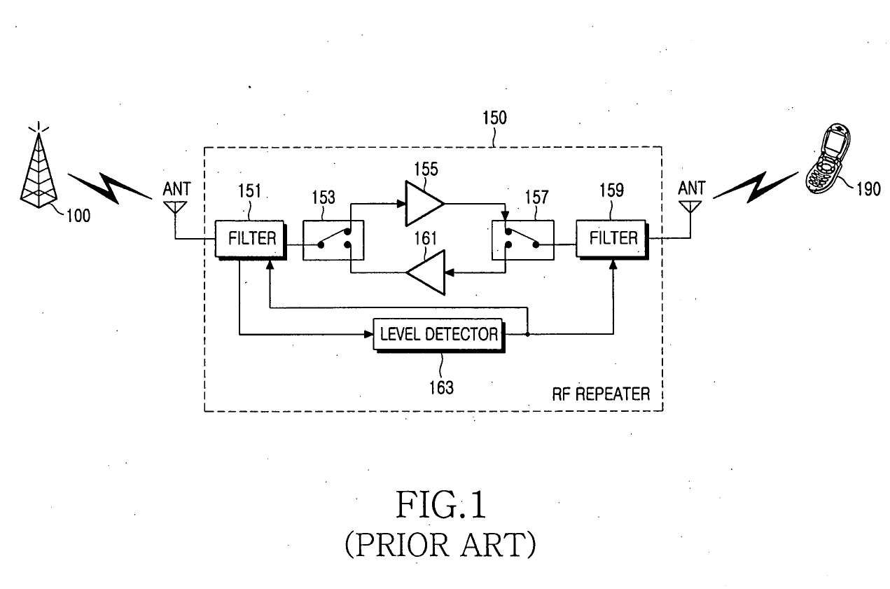

FIG. 2 illustrates the structure of an optical repeater in the typical broadband wireless communication system;

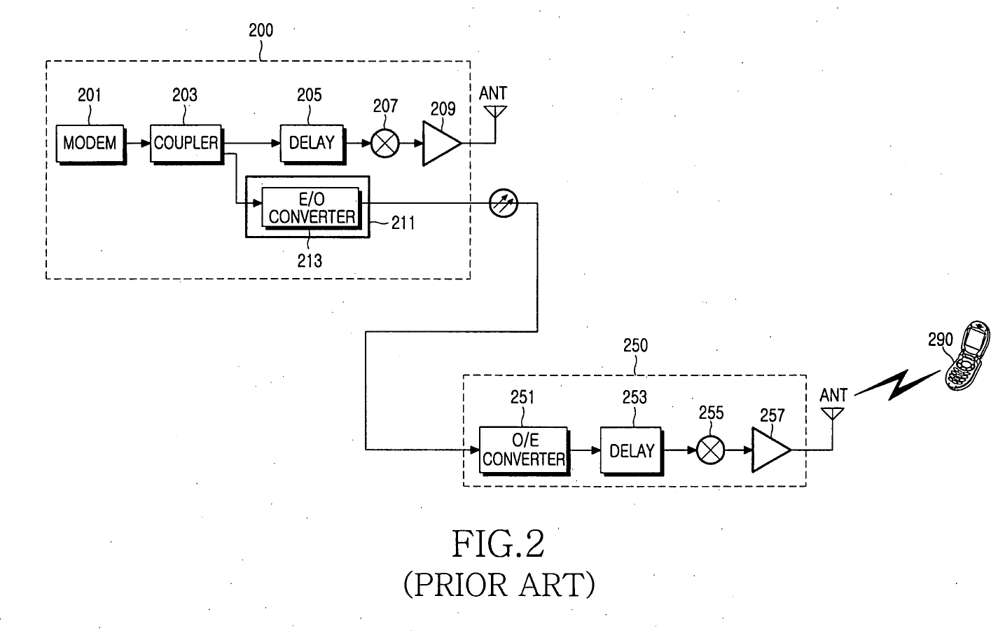

FIG. 3 illustrates a signal matching apparatus in a communication system according to an embodiment of the present invention;

FIG. 4 illustrates a bark code sent for signal matching according to the present invention;

FIG. 5 is a block diagram of a signal matching apparatus in the communication system according to another embodiment of the present invention;

FIGS. 6A to 6D illustrate Rx signal compensation for signal matching in the communication system according to the present invention; and

FIGS. 7A and 7B illustrate signal constellations of an Rx signal before and after signal matching in the communication system according to the present invention.

### DETAILED DESCRIPTION OF PREFERRED EMBODIMENTS

The following detailed description is provided to assist in a comprehensive understanding of preferred embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention provides an apparatus and method for matching Tx and Rx signals between communication devices in a communication system. The communication devices can be a transmitter and a receiver, for example. The transmitter and the receiver can be any of a BS, a repeater, and an MS. Signal matching between the communication devices according to the present invention will be described, by way of example, in the context of a communication system using a wireless communication device (e.g. an RF repeater) or an at once wired and wireless communication device (e.g. an optical repeater). An apparatus and method for signal matching with a BS or an MS are implemented in the repeaters.

In the communication system, a Direct Current (DC) subcarrier is used between wireless communication devices and a code that provides Tx-Rx switching timing information is delivered on the DC subcarrier, for signal matching between the transmitter and the receiver, i.e. signal synchronization between them. Further, for an at once wired and wireless communication device with signal measurers connected to a wired link and a wireless link, the present invention provides an apparatus and method for signal matching by compensating for the delay of Tx and Rx signals in the links, measured by the signal measurers. Transmission and reception between communication devices, for example, between a transmitter and a receiver may be carried out in TDD.

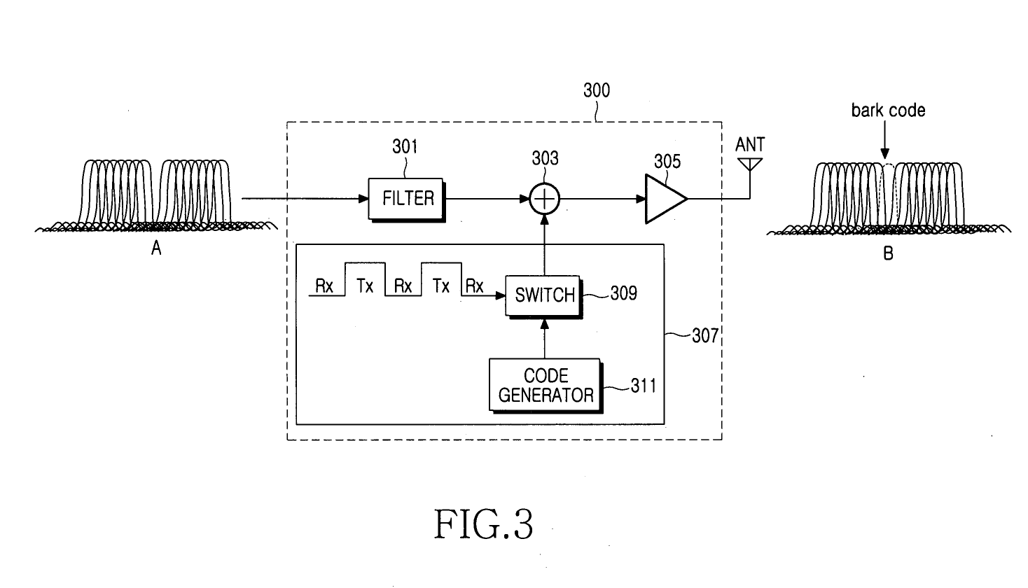

FIG. 3 illustrates a signal matching apparatus in a communication system according to an embodiment of the present invention.

Referring to FIG. 3, a BS 300 is comprised of a filter 301, a mixer 303, an AMP 305, and a signal matching apparatus 307 in the communication system. The signal matching apparatus has a switch 309 and a code generator 311.

The BS 300 can communicate with an MS directly or via a repeater. The following description is made under the assumption that the BS 300 communicates with the MS via the repeater.

In an Orthogonal Frequency Division Multiplexing (OFDM) communication system, there is a high probability that a center frequency tone (i.e. center frequency subcarrier) being a DC component in a baseband OFDM signal is blocked at the receiving end of an RF circuit. That's why the center frequency subcarrier is not used at present in the OFDM communication system.

In the BS 300, a signal A is provided to the input of the filter 301. The signal A is an OFDM signal with the center frequency subcarrier unused, for example. The filter 301 filters the signal A. The code generator 311 generates a bark code to be sent on the center frequency subcarrier. The bark code provides Tx-Rx switching timing information.

For the input of the bark code from the code generator 311 and a Tx/Rx operation signal dependent on signal transmission/reception of the BS 300, the switch 309 switches the bark code to the mixer 303 in accordance with the Tx/Rx operation signal such that the bark code can be mapped to the center frequency subcarrier.

The mixer 303 mixes the filtered signal received from the filter 301 with the bark code. The amplifier 305 amplifies the mixed signal and sends the amplified signal to a repeater or an MS through an antenna. The signal sent through the antenna, which is denoted by as signal B, includes the bark code on the center frequency subcarrier.

When the BS 300 sends the bark code through the signal matching apparatus 307, an RF repeater (not shown) acquires the Tx-Rx switching timing information of the BS 300 from the bark code, thereby accurately recovering the Tx-Rx switching timing of the BS 300.

In this way, initially, the RF repeater can recover the Tx-Rx switching timing stably even from a variable OFDM signal. Secondly, the RF repeater can acquire the Tx-Rx switching timing irrespective of variable Rx/Tx Transition Gap (RTG) and Tx/Rx Transition Gap (TTG). Thirdly, the RF repeater can recover the Tx-Rx switching timing reliably with a simplified structure. Furthermore, the use of the DC center frequency subcarrier in transmitting the bark code obviates the need for modifying existing standards.

The RF repeater may include a bark code detector for detecting the bark code. The RF repeater accurately detects the Tx-Rx switching timing of the BS 300 using the bark code, thereby acquiring synchronization.

In the opposite case, the RF repeater may have the signal matching apparatus. If the RF repeater sends the bark code on the center frequency subcarrier to the BS through the signal matching apparatus, the BS acquires synchronization by detecting the bark code. Also, the MS may be provided with the signal matching apparatus and sends the bark code on the center frequency subcarrier.

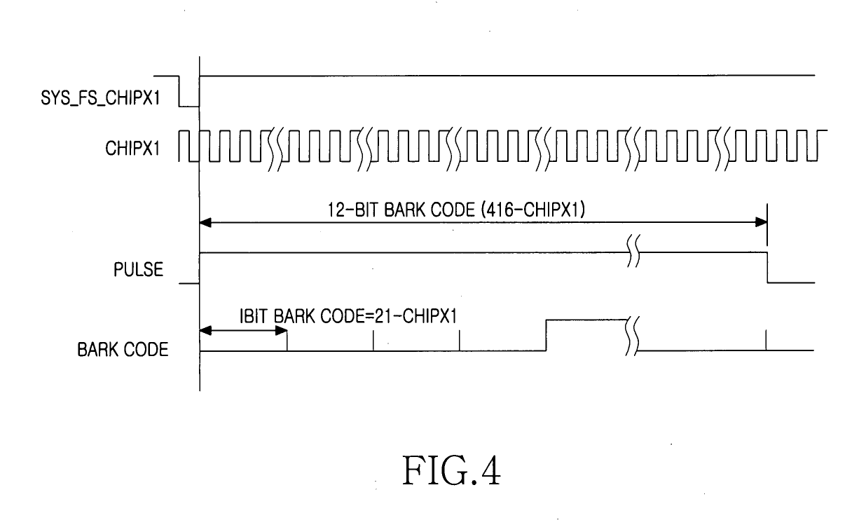

FIG. 4 illustrates a bark code sent for signal matching according to the present invention.

Referring to FIG. 4, a system clock signal SYS_FS_CHIPX1 used in the communication system, a chip clock signal CHIPX 1 of which the cycle is an integer multiple of a chip rate, and a chip clock signal corresponding to a 12-bit bark code are shown. 1-bit bark codes generated at predetermined intervals are also shown. The BS or the repeater sends the bark code on the DC center frequency subcarrier.

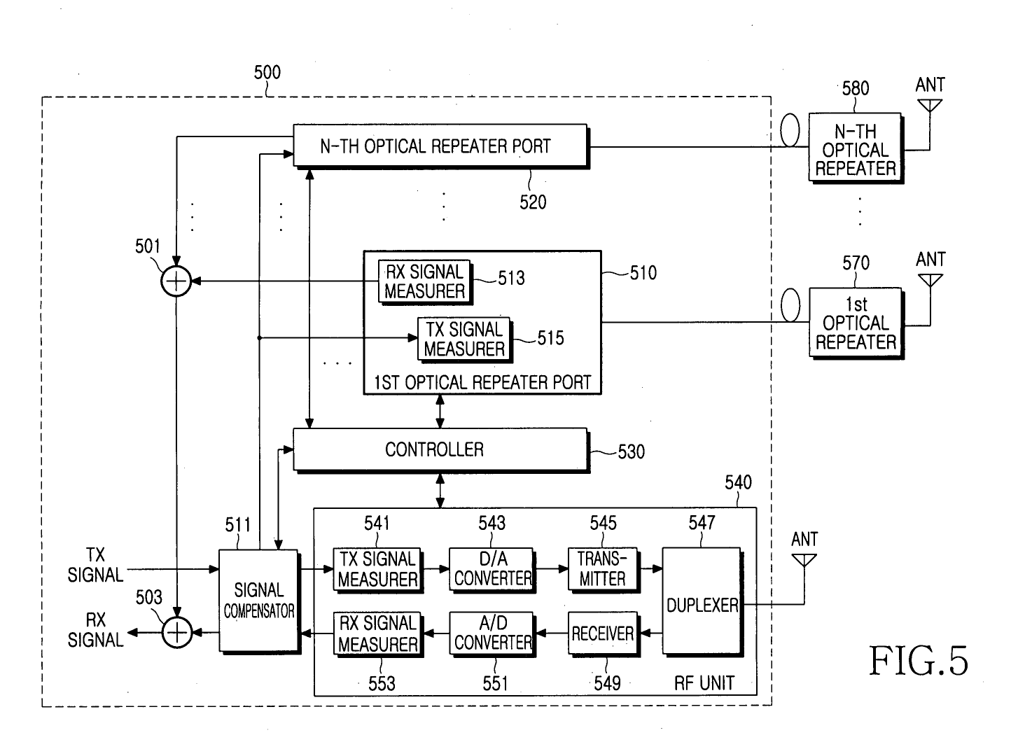

FIG. 5 is a block diagram of a signal matching apparatus in the communication system according to another embodiment of the present invention.

Referring to FIG. 5, the communication system includes a BS 500 and repeaters connected to the BS 500 by, for example, optical links, that is, first to N^{th} repeaters 570 to 580.

The BS 500 includes first to N^{th} optical repeater ports 510 to 520 in correspondence with the N optical repeaters 570 to 580. The BS 500 further includes a controller 530, an RF unit 540, a first combiner 501, a second combiner 503, and a signal compensator 511.

The BS 500 is connected to the N optical repeaters 570 to 580 by the optical links and has the N ports 510 to 520 for connection to the optical repeaters 570 to 580. Specifically, the first optical repeater port 510 is connected to the first optical repeater 570 and the N^{th} optical repeater port 520 is connected to the N^{th} optical repeater 580.

Each of the optical repeater ports 510 to 520 includes an Rx signal measurer and a Tx signal measurer. For example, the first optical repeater port 510 includes a first Rx signal measurer 513 and a first Tx signal measurer 515.

The BS 500 sends/receives signals to/from the optical repeaters 570 to 580 through the optical repeater ports 510 to 520 along the optical links. The optical repeater ports 510 to 520 measure Tx signals to be sent to and Rx signals received from the optical repeaters 570 to 580 through the Tx and Rx signal measurers under the control of the controller 530 and reports the Tx and Rx measurements to the controller 530.

The Rx signals received at the optical repeater ports 510 to 520 are provided to the first combiner 501. The first combiner 501 combines the Rx signals and provides the combined Rx signal to the second combiner 503.

The RF unit 540 includes a second Tx measurer 541, a Digital-to-Analog (D/A) converter 543, a transmitter 545, a duplexer 547, a receiver 549, an Analog-to-Digital (A/D) converter 551, and a second Rx signal measurer 553. Like the optical repeater ports 510 to 520, the RF unit 540 includes the Tx and Rx signal measurers 541 and 553 for measuring a Tx signal to be sent and an Rx signal received wirelessly through an antenna.

The second Tx signal measurer 541 measures a Tx signal received from the signal compensator 511. The D/A converter 543 converts the digital signal received from the second Tx signal measurer 541 to an analog signal. The transmitter 545 RF-processes the analog Tx signal.

The duplexer 547, which is connected to an antenna of a repeater or an MS and separates a Tx frequency from an Rx frequency, sends the signal received from the transmitter 545 through the antenna and receives an Rx signal from the antenna.

The receiver 549 processes the Rx signal received from the duplexer 547. The A/D converter 551 converts the analog signal received from the receiver 549 to a digital signal and the second Rx signal measurer 553 measures the digital signal. The RF unit 540 operates under the control of the controller 530. The second Tx and Rx signal measurers 541 and 553 measure the Tx and Rx signals under the control of the controller 530 and provide the Tx and Rx measurements to the controller 530.

The controller 530 calculates the Tx timing difference between the Tx measurements received from the first and second Tx signal measurers 515 and 541 and compensates for the Tx timing difference through the signal compensator 511, such that signals can be sent at an identical Tx timing through the optical repeater ports 510 to 520 and through the RF unit 540.

Also, the controller 530 calculates the Rx timing difference between the Rx measurements received from the first and second Rx signal measurers 513 and 553 and controls the signal compensator 511 such that signals can be received at an identical Rx timing. The signal compensator 511 compensates at least one of signals received from the optical repeater ports 510 to 520 and from the RF unit 540.

In the illustrated case of FIG. 5, the signal compensator 511 compensates a signal received in a wireless path, i.e. through the RF unit 540. It can be further contemplated as another embodiment of the present invention that an additional signal compensator is provided between the first combiner 501 and the second combiner 503 or the signal compensator 511 is so configured as to receive a signal from the first combiner 501 and output the received signal to the second combiner 503 so that a signal received in a wired path, i.e. through the optical repeater ports 510 to 520, can be compensated and in effect, signals received from both wireless and wired path can be compensated.

The controller 503 measures Tx and Rx signals through the signal measurers 513, 515, 541 and 553 and performs signal compensation to achieve the same Tx timing with respect to the wired and wireless Tx paths and the same Rx timing with respect to the wired and wireless Rx paths. After the reception timing synchronization, the controller 530 combines the Rx signals at the second combiner 503, thus detecting a final Rx signal.

The controller 530 controls the signal compensator 511 to compensate for the time delay of a Tx signal to be sent through the optical repeater ports 510 to 520 or through the RF unit 540, so that Tx signals can be sent at the same Tx timing.

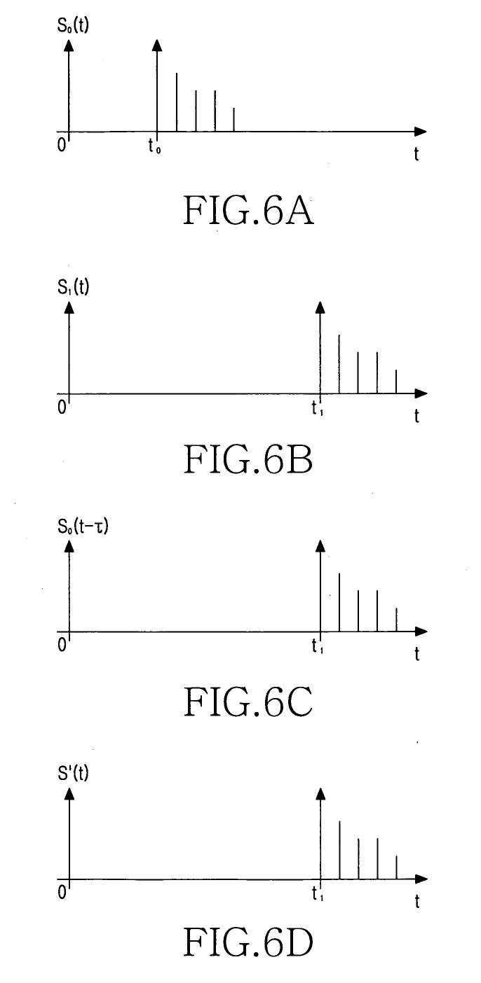

For this purpose, the signal compensator 511 may include a delay. For example, if a first Tx signal to be sent through the first optical repeater port 510 is earlier in Tx timing than a second Tx signal to be sent through the RF unit 540, the first is delayed. In the opposite case, i.e. if the second Tx signal is earlier in Tx timing than the first Tx signal, the second Tx signal is delayed. Rx signal compensation at the signal compensator 511 will be described later with reference to FIGS. 6A to 6D.

As described above, for Tx signal compensation, the signal compensator 511 delays at least one of signals to be sent through the wired path and through the wireless path so that the Tx timing is synchronized between the wired and wireless paths. Similarly, for Rx signal compensation, the signal compensator 511 delays at least one of signals received through the wired path and through the wireless path so that the Rx timing is synchronized between the wired and wireless paths.

The Rx signal of the RF unit 540 output from the signal compensator 511 is combined with the Rx signal from the first combiner 501 in the second combiner 503.

To improve reception performance, the BS 500 combines Rx signals received through the optical repeater ports 510 to 520 with an Rx signal received through the signal compensator 511 by an RF combining scheme. The BS may also improve link performance by selectively applying a soft combining scheme in which the signals are combined in the second combiner 503 after digital signal processing.

For the BS 500, the signal matching apparatus includes the signal measurers 513, 515, 541 and 533, the signal compensator 511, and the controller 530. The signal measurers are the first Tx and Rx signal measurers in the optical repeater ports 510 to 520 and the second Tx and Rx signal measurers 541 and 553 of the RF unit 540. The positions of the signal measurers and the signal compensator 511 in FIG. 5 are shown for better understanding of the present invention, to which the present invention is not limited.

FIGS. 6A to 6D illustrate Rx signal compensation for signal matching in the communication system according to the present invention.

Referring to FIGS. 6A and 6B, the RF unit receives a signal S₀(t) at time t₀ and an optical repeater port receives a signal S₁(t) at time t₁. That is, the RF unit and the optical repeater port receive the signals at different Rx timings. Assume that, the Rx timing difference between the RF unit and the optical repeater port is longer than the length of a CP.

The controller calculates the Rx timing difference τ by Equation (1):
τ=t₁−t₀ (1)

The signal compensator compensates the Rx signal of the RF unit under the control of the controller. The compensated signal is denoted by S₀(t−τ) in FIG. 6C. The signal compensator then compensates the signal S₀(t−τ) using the signal S₁(t) within an allowed CP length. The final compensated signal S′(t) is shown in FIG. 6D.

The signal compensation fulfills the following condition shown in Equation (2):
t₁−t₀−τ+Δ₁<CPLength (2)

where Δ₁ denotes an allowed error within the CP length.

While the signal of the RF unit is compensated in the above description, it is a mere exemplary application. Hence, it is further contemplated that the signal compensator is provided at the output ends of the optical repeater ports to compensate signals from the optical repeater ports.

Tx signal compensation and Rx signal compensation are performed by delaying Tx signals to be sent through the optical repeater ports or a Tx signal to be sent through the RF unit, and delaying Rx signals received through the optical repeater ports or an Rx signal received through the RF unit, so that Tx timing and Rx timing are synchronized between the Tx signal and between the Rx signals. Particularly in the Rx signal compensation, the Rx signal is delayed to fall within a CP length.

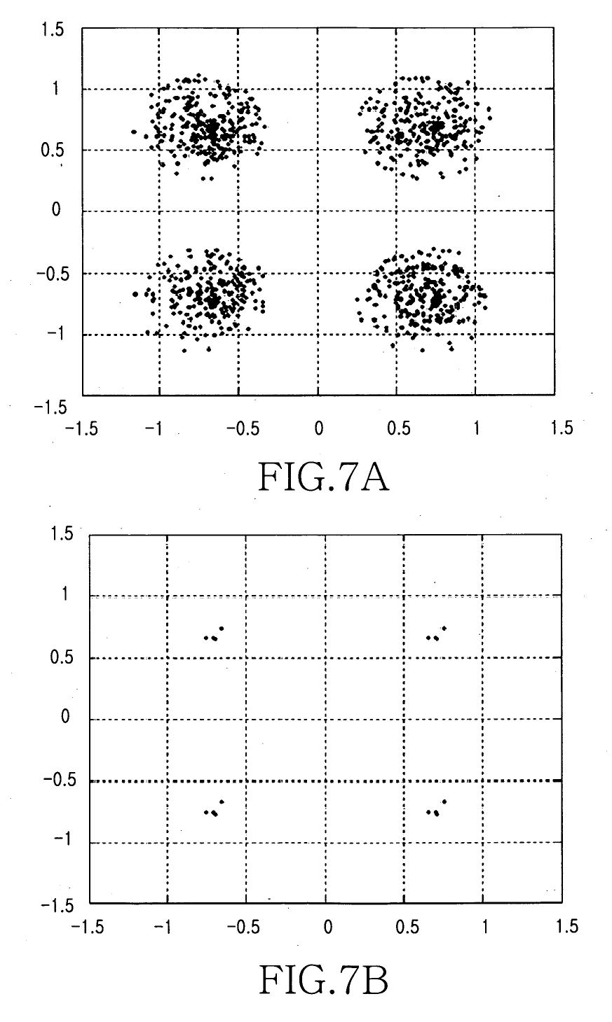

FIGS. 7A and 7B illustrate signal constellations of an Rx signal before and after signal matching between communication devices, for example, between the BS and the repeater in a wireless communication system according to the present invention.

Referring to FIG. 7, in order to acquire signal constellations, the following conditions are assumed: a 256-point Fast Fourier Transform (FFT), Quadrature Phase Shift Keying (QPSK), an Additive White Gaussian Noise (AWGN) channel with a Signal-to-Noise Ratio (SNR) of about 30 dB, and a CP length of 64.

In the case where the BS receives a signal with a synchronization error of 15 μsec in a signal model normalized to E(x²)=1, FIG. 7A illustrates the signal constellation of an Rx signal in the BS before the present invention is applied and FIG. 7B illustrates the signal constellation of the Rx signal in the BS when the present invention is applied. A comparison between FIGS. 7A and 7B reveals that the present invention improves the signal constellation of the Rx signal.

As described above, the exemplary embodiments of the present invention provide a signal matching apparatus and method in a broadband wireless communication system, which enable accurate detection of Tx and Rx signals between a transmitter and a receiver through signal matching between communication devices connected wirelessly or at once wiredly and wirelessly. Also, Tx and Rx synchronization is acquired between the transmitter and the receiver and application of the signal matching method to a communication system using, for example, a repeater can increase total system performance by accurate signal transmission and reception. Furthermore, while the present invention has been described above with reference to a communication system which operates in an OFDM scheme, other communication systems are also contemplated, such as for example, an Orthogonal Frequency Division Multiple Access (OFDMA) system.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. A signal matching method in a communication system, comprising:
generating a synchronization code for synchronization acquisition; and
including the synchronization code on a center frequency subcarrier of a transmission signal and sending the transmission signal to a receiver, for signal matching.

2. The signal matching method of claim 1, wherein the communication system operates in at least one of Orthogonal Frequency Division Multiplexing (OFDM) and Orthogonal Frequency Division Multiple Access (OFDMA).

3. The signal matching method of claim 1, wherein the synchronization code includes timing information associated with switching between transmission and reception.

4. The signal matching method of claim 1, wherein the central frequency subcarrier is a Direct Current (DC) subcarrier.

5. The signal matching method of claim 1, further comprising mixing the synchronization code with the transmission signal according to a transmission and reception operation signal dependent on transmission and reception of a transmitter that sends the synchronization code.

6. A signal matching method in a communication system, comprising:
receiving a signal including a synchronization code for synchronization acquisition;
detecting the synchronization code from a center frequency subcarrier of the received signal; and
performing signal matching to a transmitter that sends the synchronization code, using the synchronization code.

7. The signal matching method of claim 6, wherein the communication system operates in at least one of Orthogonal Frequency Division Multiplexing (OFDM) and Orthogonal Frequency Division Multiple Access (OFDMA).

8. The signal matching method of claim 6, wherein the synchronization code includes timing information associated with switching between transmission and reception.

9. The signal matching method of claim 6, wherein the central frequency subcarrier is a Direct Current (DC) subcarrier.

10. A signal matching method in a communication system, comprising:
measuring transmission signals to be sent through a wired link and a wireless link and measuring reception signals received through the wired link and the wireless link;
sending the transmission signals through the wired link and the wireless link by compensating for the difference between transmission timings of the transmission signals so that the transmission timings are synchronized to each other; and
receiving the reception signals through the wired link and the wireless link by compensating for the difference between reception timings of the received signals so that the reception timings are synchronized to each other.

11. The signal matching method of claim 19, wherein compensating for the difference between the transmission timings of the transmission signals comprises delaying at least one of a first signal to be sent through the wired link and a second signal to be sent through the wireless link so that the transmission timings are synchronized to each other.

12. The signal matching method of claim 19, wherein compensating for the difference between the reception timings of the reception signals comprises delaying at least one of a first signal received through the wired link and a second signal received through the wireless link so that the reception timings are synchronized to each other.

13. The signal matching method of claim 12, wherein delaying at least one of a first signal received through the wired link and a second signal received through the wireless link comprises delaying the at least one of the first and second signals within a Cyclic Prefix (CP) length.

14. The signal matching method of claim 10, further comprising recovering the reception signals by combining the reception signals.

15. The signal matching method of claim 14, wherein recovering a received signal by combining the reception signals comprises combining the reception signals using at least one of Radio Frequency (RF) combining and soft combining.

16. A signal matching apparatus in a communication system, comprising:
a transmitter for generating a synchronization code for synchronization acquisition, including the synchronization code on a center frequency subcarrier of a transmission signal, and sending the transmission signal to a receiver, for signal matching.

17. The signal matching apparatus of claim 16, wherein the transmitter includes:
a code generator for generating the synchronization code; and
a switch for switching the synchronization code so that the synchronization code is included on the center frequency subcarrier of the transmission signal.

18. The signal matching apparatus of claim 17, wherein the switch receives a transmission and reception operation signal dependent on transmission and reception of the transmitter and switches the synchronization code according to the transmission and reception operation signal.

19. The signal matching apparatus of claim 16, wherein the communication system operates in at least one of Orthogonal Frequency Division Multiplexing (OFDM) and Orthogonal Frequency Division Multiple Access (OFDMA).

20. The signal matching apparatus of claim 16, wherein the synchronization code includes timing information associated with switching between transmission and reception.

21. The signal matching apparatus of claim 16, wherein the central frequency subcarrier is a Direct Current (DC) subcarrier.

22. A signal matching apparatus in a communication system, comprising:
a receiver for receiving a signal including a synchronization code for synchronization acquisition, detecting the synchronization code from a center frequency subcarrier of the received signal, and performing signal matching to a transmitter that sends the synchronization code using the synchronization code.

23. The signal matching apparatus of claim 22, wherein the communication system operates in at least one of Orthogonal Frequency Division Multiplexing (OFDM) and Orthogonal Frequency Division Multiple Access (OFDMA).

24. The signal matching apparatus of claim 22, wherein the synchronization code includes timing information associated with switching between transmission and reception.

25. The signal matching apparatus of claim 22, wherein the central frequency subcarrier is a Direct Current (DC) subcarrier.

26. The signal matching apparatus of claim 22, wherein the receiver is one of a Base Station (BS), a repeater, and a Mobile Station (MS).

27. A signal matching apparatus in a communication system, comprising:
a signal measuring portion for measuring transmission signals to be sent through a wired link and a wireless link and measuring reception signals received through the wired link and the wireless link;
a signal compensator for compensating for the difference between transmission timings of the transmission signals so that the transmission timings are synchronized to each other, and compensating for the difference between reception timings of the received signals so that the reception timings are synchronized to each other; and
a controller for receiving transmission signal measurements and reception signal measurements from the signal measuring portion and controlling the signal compensator to compensate for the difference between the transmission timings of the transmission signals and compensate for the difference between the reception timings using the transmission signal measurements and the reception signal measurements.

28. The signal matching apparatus of claim 27, wherein the signal measuring portion includes:
a first transmission signal measurer for measuring the transmission signal to be sent through the wired link and providing a transmission signal measurement to the controller;
a first reception signal measurer for measuring the reception signal received through the wired link and providing a reception signal measurement to the controller;
a second transmission signal measurer for measuring the transmission signal to be sent through the wireless link and providing a transmission signal measurement to the controller; and
a second reception signal measurer for measuring the reception signal received through the wireless link and providing a reception signal measurement to the controller.

29. The signal matching apparatus of claim 27, wherein the signal measuring portion compensates for the difference between the transmission timings of the transmission signals by delaying at least one of a first signal to be sent through the wired link and a second signal to be sent through the wireless link so that the transmission timings are synchronized to each other.

30. The signal matching apparatus of claim 27, wherein the signal measuring portion compensates for the difference between the reception timings of the reception signals by delaying at least one of a first signal received through the wired link and a second signal received through the wireless link so that the reception timings are synchronized to each other.

31. The signal matching apparatus of claim 27, further comprising a combiner for combining the reception signals to recover the reception signals.

32. The signal matching apparatus of claim 31, wherein the combiner combines the reception signals using at least one of Radio Frequency (RF) combining and soft combining.
